(19) United States
(12) Patent Application Publication
(10) Pub. No.: US 2013/0245800 A1
(43) Pub. Date: Sep. 19, 2013

(54) METHOD OF PRODUCING KITTING FOAM

(71) Applicant: REPLICADE LIMITED, Stewarton (GB)

(72) Inventors: Joseph Robert Carty, Stewarton (GB); Alistair David Carty, Glasgow (GB)

(73) Assignee: REPLICADE LIMITED, Stewarton (GB)

(21) Appl. No.: 13/794,883

(22) Filed: Mar. 12, 2013

(30) Foreign Application Priority Data
Mar. 15, 2012 (GB) 1204603.3

(51) Int. Cl. G06F 17/50

(52) U.S. Cl. CPC G06F 17/50
USPC 700/98

(57) ABSTRACT

A method of producing a kitting foam, a kitting foam produced by such a method and a system for performing such a method is provided. Once a 2.5-dimensional computer model has been created using a Computer-Aided Design (CAD) package in computer 40 using a photograph and depth information, the model is input to a Computer Aided Manufacturing (CAM) package being stored and ran on a second computer 42 which may be part of, or may be configured to communicate with, an automated cutting machine 44. The CAM package derives the most efficient cutter path for cutting out a pocket in a kitting foam blank in accordance with the 2.5-dimensional computer model. The pocket has a varying depth profile conforming to the varying depth profile of the three dimensional shape of the computer model.

### BACKGROUND

Kitting foams (also known as foam insert restraints) are commonly used to prevent tools from moving about freely within containers such as tool-boxes, kits, assembly jigs and drawers. Conventionally, an outline of each tool is cut into a foam blank (by hand or by an automated cutting machine) to provide a cut-out in which the tool can be placed. A typical cutting path followed by an automated cutting machine to form such a cut-out is shown in FIG. 1.

The cutting tool is typically set to cut the outline of each tool through the entire thickness of the foam. As such, a layer of backing material is typically bonded to the back of the kitting foam to prevent the tool being restrained from falling through the cut-out. The backing material typically has a colour which contrasts that of the kitting foam. As the cut-out in the foam blank provides an aperture through which the backing material can be seen, the backing material thus also provides an alarm system which indicates when a tool is missing from the kitting foam. This helps prevent tools from being left in areas which could be potentially hazardous.

A problem with existing kitting foam production techniques (as described in, for example, US20100193385) is that the cut-out in the kitting foam has a constant depth. This typically makes it necessary to provide a further cut-out in the foam blank which provides a finger hole/groove allowing an engineer to easily lift tools from the foam. However, the finger hole/groove exposes more of the backing material. The constant exposure of the backing material, caused by the finger hole/groove, causes users to become used to exposed areas of the contrasting colour. This in turn makes the alarm system less effective.

Another problem with the method described in US20100193385 is that, once the kitting foam has been produced, it is necessary to attach the backing material in a post-production processing step which increases complexity, time and cost required to complete to the process.

SUMMARY OF INVENTION

A first aspect of the disclosure provides a method of producing a kitting foam, the method comprising:
a. providing a foam blank;
b. providing a computer model of a three dimensional shape having a varying depth profile;
c. deriving a cutter path at least partly from the computer model; and
d. cutting the foam blank along the cutter path to form a pocket in the foam blank, the pocket having a varying depth profile conforming to the varying depth profile of the three dimensional shape.

The method may further comprise removing cut portions of the foam blank to form the pocket. Preferably the cut portions of the foam blank are removed as part of the cutting procedure in step d.

Typically the pocket comprises an opening. Typically the pocket further comprises a base. Preferably the pocket comprises one or more side walls extending from the base towards the opening.

The opening is typically formed in an upper surface of the kitting foam. Typically, the opening is defined by the perimeter of the pocket (in other words, by uncut portions of the foam blank) and optionally by one or more edges of the foam blank.

In one embodiment the pocket comprises an opening. At least part of the opening may be located on a plane and at least part of the varying depth profile of the pocket may extend into the foam from the opening in a direction perpendicular to that plane.

Preferably the pocket comprises opposing pairs of side walls, each side wall extending from a respective edge of the base.

Although the cutter path may be derived only partly from the computer model, preferably the cutter path is derived solely from the computer model.

The pocket is typically suitable for restraining an object/tool in the kitting foam.

By providing the pocket with a varying depth profile, an object restrained by (or held in) the pocket can easily be lifted out of the pocket without having to provide the kitting foam with separate finger holes. This helps to maintain the integrity of “missing tool” alarm systems such as layered, contrasting colour systems described in the Background section above because it is no longer necessary to constantly expose areas of contrasting colour to the user.

By deriving the cutter path from a computer model of a three dimensional shape having a varying depth profile, a pocket having a varying depth profile conforming to that of the three dimensional shape can be cut out of the foam blank in a single cutting operation along a single, optimised cutter path. This allows the pocket to be formed with optimum speed and efficiency. Additionally, as it is not necessary to perform multiple independent cutting operations on the foam (which would require a cutting tool to be realigned between successive cutting operations), the manufacturing process is highly accurate. This makes the manufacture of small quantities of (and even single “one-off”) high quality kitting foams cost effective.

Typically, and preferably, the cutter path is substantially continuous. Even more preferably, the cutter path may be fully continuous.

The cutter path is typically a three dimensional cutting path which traverses a varying depth profile (which typically conforms to the varying depth profile of the three dimensional shape).

A three dimensional shape having a “varying depth profile” is typically a three dimensional shape which, as a whole, has a plurality of different heights in the z-dimension, the z-dimension in this case typically comprising the principle direction in which an object may be inserted into the pocket (and/or the principle direction in which the cutting tool cuts into the foam during step d).

The computer model may, in one embodiment, comprise or consist of a plurality of three dimensional co-ordinates representing the desired shape of the pocket.

The computer model may be a full 3D model which is fully derived from the shape of an object to be restrained by (or held in) the pocket (where distinct z-dimension values are provided for each (x, y) position on the model). However, more preferably, the computer model is a 2.5D model. A 2.5D computer model differs from a full 3D model in that only a limited amount of z-dimension (depth) information is provided. Typically, the same z-dimension co-ordinate value is provided for a plurality of (x, y) co-ordinates in a 2.5D model even if the base of the object to be held by the pocket at those (x, y) co-ordinates is not flat (e.g. the base of the object may be contoured), whereas a distinct z-dimension co-ordinate value is provided for each (x, y) co-ordinate in a full 3D model.

The 2.5D computer model typically comprises a silhouette in first and second dimensions of an object to be held by the pocket (that is, a 2D outline or a “plan profile” of the shape of the object). It will be understood that the first and second dimensions are typically different—e.g. the first and second dimensions may be x and y dimensions. The 2.5D computer model also typically comprises at least first and second depths in a third dimension, the first depth being different from the second depth. It will be understood that the third dimension is typically different from the first and second dimensions—e.g. the third dimension may be the z-dimension. Typically, the first depth in the third dimension is provided for a first plurality of adjacent points on the silhouette, and the second depth in the third dimension is provided for a second plurality of adjacent points on the silhouette, even if the base of the object from which the model is derived is not flat (e.g. contoured) at those points.

The 2.5D computer model typically further comprises a depth transition line indicating where the depth of the computer model in the third dimension changes from the first depth to the second depth. In this case, the pocket may comprise a base comprising a step between the first and second depths in the third dimension in accordance with the depth transition line. Where more than two depths are provided in the third dimension, a plurality of corresponding depth transition lines may be provided. The depth transition lines may be, but are not necessarily straight. For example, the depth transition lines may be curved or stepped.

The silhouette may comprise a plurality of (x, y) co-ordinates from around the shape of the object. Additionally or alternatively, the silhouette may comprise a mathematical formula/representation of the outline shape of the object.

Preferably, the opening of the pocket is shaped in accordance with the silhouette.

A 2.5D model is preferable over a full 3D model because it does not require expensive equipment (such as a laser scanner) to derive, the final model typically requires less processing and it is quicker to derive from an object. In addition, the inventors have discovered that a 2.5D model is more than sufficient to provide pockets in the kitting foam with the desired profile which fit snugly around the objects/tools they are required to restrain.

Typically the first, second and third dimensions are orthogonal to each other.

In a preferred embodiment, the method further comprises generating the computer model by: obtaining a silhouette of an object in first and second dimensions; providing first and second depths in a third dimension, the first depth being different from the second depth; and providing a depth transition line indicating where the depth in the third dimension changes from the first depth to the second depth.

The silhouette may be obtained from a (typically digital) photograph of the object, either automatically by a Computer Aided Design (CAD) program, or manually by tracing points around the outside of the shape of the image of the object.

In one embodiment, the method according to the first aspect of the disclosure further comprises: referencing the silhouette of the object to a plurality of fiducial points separated by a predetermined distance to scale the silhouette in accordance with the size of the object. This allows a pocket of the appropriate scale to be formed in the kitting foam without any further user input. In this case, the method may further comprise taking a photograph of the object against a reference background comprising the fiducial points.

Typically the method further comprises storing the generated computer model in a library of computer models.

In one embodiment, as an alternative to generating the computer model as described above, the computer model may be selected from a library of predetermined computer models in step b. The predetermined computer models may have been originally derived using the photographic method described above or using any suitable alternative method.

By storing and/or selecting the computer models in a library/catalogue of models, subsequent kitting foams comprising pockets in accordance with the selected models can be designed and manufactured quickly, flexibly and easily without having to regenerate the models from the objects.

In one embodiment, the method further comprises using a computer aided manufacturing software package to derive the cutter path in step c. The computer aided manufacturing software package typically calculates an optimised cutter path in accordance with the computer model.

In one embodiment, step d comprises controlling the cutting tool with a computer aided manufacturing software package.

Typically the cutting tool is an automated cutting tool. Where a computer aided manufacturing software package is used, it is typically run on a computer which is part of, or configured to communicate with, the automated cutting tool.

In one embodiment, the cutting tool is a CNC cutting machine.

In a preferred embodiment, the method according to the first aspect of the disclosure may further comprise providing a computer model of a plurality of three dimensional shapes each shape having a varying depth profile; deriving a cutter path from the computer model; and cutting the foam blank along the cutter path to form a plurality of pockets in the foam blank, each pocket having a varying depth profile which conforms to the varying depth profile of a respective one of the three dimensional shapes.

The plurality of shapes may be derived from the same object or from different objects.

By providing a plurality of such models to the computer before the cutting procedure in step d, the computer can calculate a single (preferably substantially continuous), optimised three dimensional cutter path which traverses a varying depth profile. Thus, complex kitting foams for restraining a plurality of different (or the same) tools can be manufactured in a single cutting operation. As explained above, this provides a quick and accurate method of producing high quality kitting foams.

Typically the foam blank comprises a first layer stacked on a second layer. The first layer may be attached (e.g. bonded) to the second layer, or the first and second layers may be integrally formed with each other. Preferably, the first layer comprises a first colour and the second layer comprises a second colour, the first colour contrasting with the second colour. In this case, the method preferably further comprises an opening, step d further comprising cutting through the first layer so that the second layer is visible through the opening. The contrasting colour of the second layer relative to the first layer may provide an alarm system, alerting a user when a tool is missing from the pocket.

By providing a blank comprising first and second layers (either attached or integrally formed) having contrasting colours, no additional layers need to be provided to form the alarm system. By avoiding the post-processing requirement, the kitting foam production process becomes much more efficient.

Preferably, step d comprises cutting through none of or only part of the thickness of the second layer so that the foam retains its structural integrity. This again helps to prevent post-processing as it is no longer necessary to attach a further layer onto the kitting foam to provide additional strength and/or to prevent the tools from falling through the back of the kitting foam.

A second aspect of the disclosure provides a kitting foam manufactured by the method according to the first aspect of the disclosure.

A third aspect of the disclosure provides a system for performing the method according to the first aspect of the disclosure, the system comprising: a computer loaded with a computer aided manufacturing software package capable of deriving a cutter path at least partly from a computer model of a three dimensional shape having a varying depth profile; and an automated cutter capable of cutting a foam blank along the cutter path to form a pocket in the foam blank, the pocket having a varying depth profile conforming to the varying depth profile of the three dimensional shape.

Typically, the computer comprises a memory storing the computer aided manufacturing software package and a processor for running the computer aided manufacturing software package.

The system according to the third aspect of the disclosure may further comprise: a camera; and a computer loaded with a computer aided design software package capable of generating the computer model at least partly from a photograph taken by the camera.

The computer loaded with the computer aided manufacturing software package may be the same computer as that loaded with the computer aided design software package. Alternatively, different computers may be provided.

The computer loaded with the computer aided design software package typically comprises a memory storing the computer aided design software package and a processor for running the computer aided design software package.

Additionally or alternatively, the system according to the third aspect of the disclosure may further comprise a computer memory storing a plurality of computer models, each representing a different three dimensional shape having a varying depth profile. The computer memory storing the plurality of computer models may be comprised in the computer loaded with the computer aided manufacturing package and/or the computer loaded with the computer aided design software package. Alternatively a separate memory may be provided.

Typically, the computer loaded with the computer aided manufacturing package is in electronic communication with the automated cutter.

### BRIEF DESCRIPTION OF DRAWING

An embodiment of the disclosure will now be described, by way of example only, with reference to the drawing, in which:

FIG. 1 shows a typical, single depth cutting path;

FIG. 2 is a schematic cross section of a kitting foam blank comprising a top layer stacked on a bottom layer;

FIG. 3 is a schematic cross section of a kitting foam comprising a pocket cut out of a kitting foam blank according to FIG. 1;

FIG. 4 illustrates a method of obtaining a computer model corresponding at least partly to the shape of a tool;

FIG. 5 is a schematic cross section of a kitting foam holding a tool within a pocket having a step down at one end;

FIG. 6 is a computer representation of a 2.5D computer model of a tool;

FIG. 7 illustrates a process flow for obtaining a kitting foam with one or more pockets, each having a plurality of different depths; and

FIG. 8 illustrates a three dimensional cutter path derived in accordance with the present disclosure.

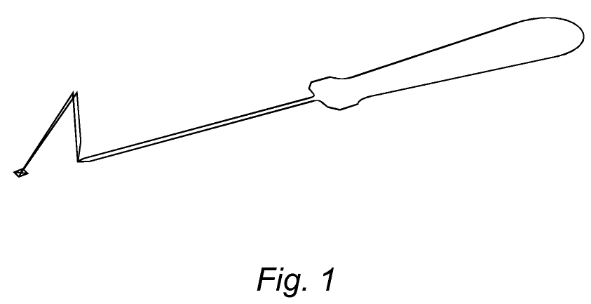

### DESCRIPTION OF SPECIFIC EMBODIMENTS

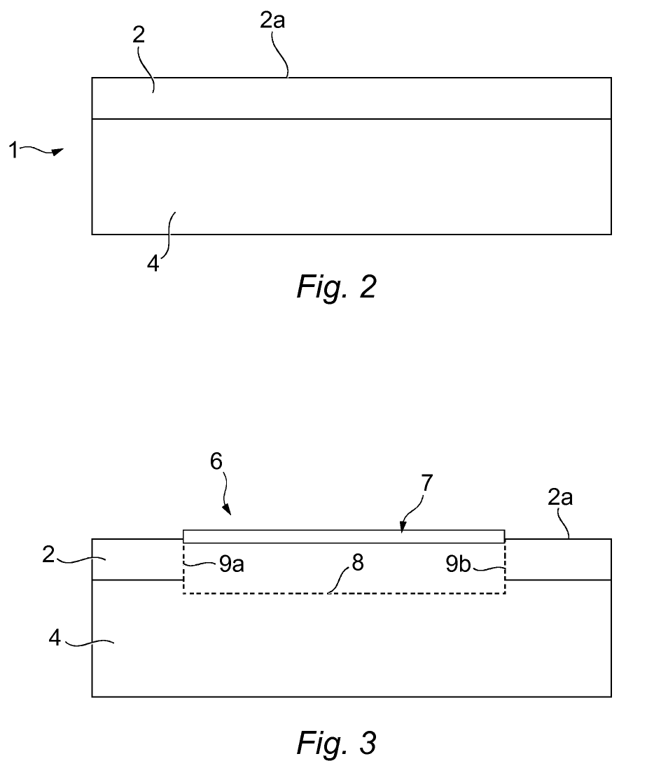

FIG. 2 is a schematic cross section of a kitting foam blank 1 comprising a top layer 2 stacked on a bottom layer 4. Layers 2, 4 may be attached (e.g. bonded) together or, alternatively, they may be integrally formed with each other. The top layer 2 has a colour which contrasts that of the bottom layer 4—e.g. the top layer may be black, while the bottom layer 4 may be yellow (or vice versa).

Kitting foams are typically used to prevent tools from moving about freely within containers. Tools may be held within pockets cut out of the foam blank 1. Such a pocket 6 is illustrated schematically in FIG. 3. The pocket 6 comprises an opening 7 formed in the upper surface 2a of the kitting foam blank (defined by uncut portions of the kitting foam surrounding the pocket 6), a base 8 and opposing pairs of side walls (one such pair 9a, 9b being shown in the sectional view of FIG. 3) extending from respective edges of the base 8 towards the opening 7. The pocket 6 extends through the upper layer 2 such that the bottom layer 4 is visible through the opening 7. The contrasting colour of the bottom layer 4 against remaining portions of the top layer 2 provides an alarm system indicating when a tool is absent from the pocket 6. This is particularly useful in toolboxes used in maintenance environments, where it is of critical importance not to leave any tools in the machinery being maintained.

As well as being cut through the top layer 2, the pocket 6 may be cut through a portion of the bottom layer 4. However, the bottom layer 4 is typically thicker than the top layer 2 so that a sufficient amount of the bottom layer 4 remains intact when the pockets are cut out of the blank 1 in order to retain the structural integrity of the foam.

Because the two layers 2, 4 are either attached (e.g. bonded) together or integrally formed before a pocket 6 is formed in the kitting foam blank 1, the final kitting foam product is produced as soon as the desired pocket(s) 6 is (are) cut out from the blank 1. That is, no additional layers need to be bonded to the kitting foam after the pocket(s) have been formed as in more conventional procedures. This makes the process simpler, quicker and more efficient.

In order to provide a pocket which fits snugly around a given tool (thus providing a secure restraint for the tool within the foam), it is desirable to cut out the pocket accurately in accordance with the shape of that tool. Manual cutting is costly, time consuming and prone to error. Therefore, an automated cutting machine (such as a CNC machine) may be used to cut out the pocket 6. Automated cutting machines need to be provided with cutter paths which they can follow to cut out pockets of the required shape. Such cutter paths can be calculated from computer models derived at least partly from the shape of the tools to be held within the kitting foam.

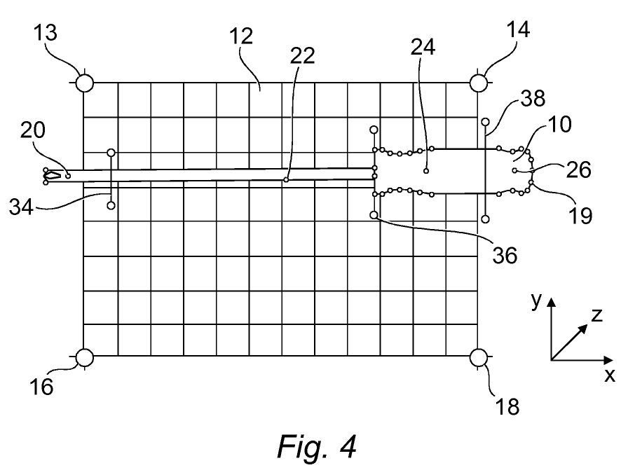

FIG. 4 illustrates a method of obtaining a 2.5 dimensional (2.5D) computer model of a tool 10 (in this case a screwdriver) to be held in a kitting foam. The tool 10 is placed against a reference background 12 comprising a plurality (in this case four, but any number greater than one may be used) of fiducial points 13, 14, 16, 18, the spacing between the fiducial points being predetermined. More than one fudicial point would provide a reference along one axis; more than two fudicial points, at least one of which is not co-linear with the other points, would provide a reference along a plurality of axes. The latter is more typically employed because a reference along a plurality of axes is typically required.

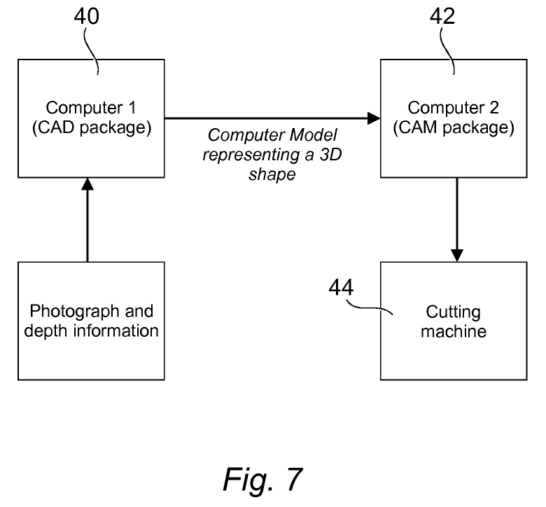

A (typically) digital photograph is taken of the tool 10 against the reference background 12 and input to a Computer Aided Design (CAD) software package stored and ran on a computer 40 (see FIG. 7). An example of a suitable CAD package would be “AutoCAD”. Next, a 2D (in this case the x and y dimensions) model of the shape (or “silhouette”) of the tool 10 is obtained by selecting a number of points 19 around the perimeter of the image of the tool 10 on the digital photograph. This can be done automatically by the CAD package or by manually tracing around the perimeter of the image of the tool 10. The space between the points may then be interpolated by the CAD package to increase the resolution of the 2D model. The (interpolated) 2D model can then be scaled in accordance with the known distance between the fiducial points 13, 14, 16, 18 to provide a 2D model scaled to the actual size of the tool 1. This process used to reference the 2D model of an object on a photograph to fiducial points separated by a known distance is known as soft photogrammetry.

Next, depth information in the z-dimension is added to the 2D model to provide a 2.5D model. For a 2.5D computer model, only a limited amount of z-dimension information is provided. Typically, one z-dimension value is provided for a plurality of (x, y) points in the 2D model. This may provide the pocket 6 with a substantially flat base (albeit distinct flat areas at different depths are typically provided), even if the tool 10 does not have a correspondingly flat base.

Although it will be understood that it is dependent on the complexity of the shape of the tool 10, a 2.5D model may comprise less than twenty distinct z-dimension values, less than ten distinct z-dimension values or even less than five distinct z-dimension values (some of which may be equal, but at least two of which are typically different), even when there are hundreds or even thousands of distinct (x, y) points in the 2D model.

In the case of FIG. 4, four distinct z-dimension values 20, 22, 24, 26 are provided. The depth information is typically derived from manually measuring the height of the tool at various points along its length (and optionally at various points along its width) and selecting depths in the z-dimension that would provide the tool with a desired (typically flat) profile when placed within the pocket.

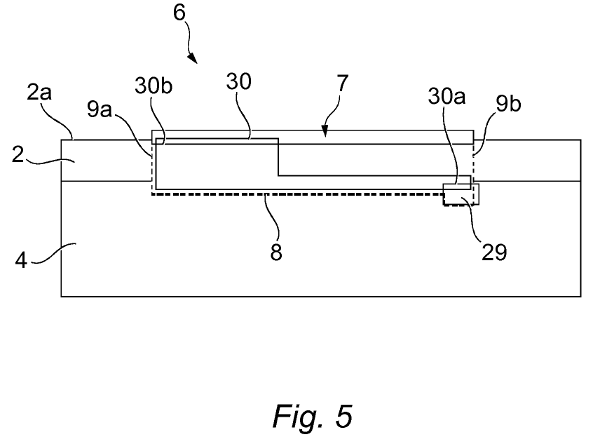

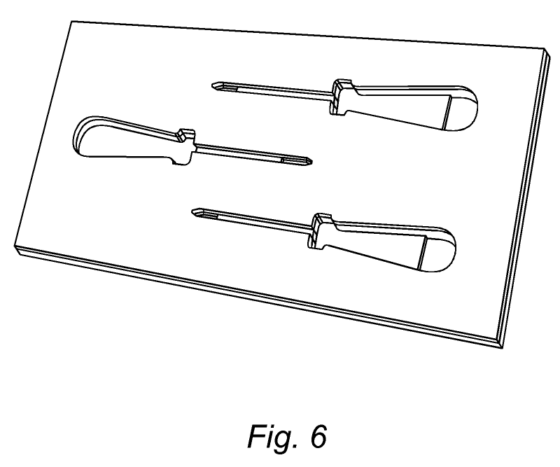

Additionally or alternatively, z-dimensions may be selected to provide one or more “step-downs” 29 (i.e. recesses provided in the base of the pocket below the level where the tool sits) in the base 8 of the pocket 6. Step-downs 29 provide a means for easily lifting a tool out of the pocket, eliminating the need for finger grooves in the kitting foam. This is illustrated in FIG. 5 which shows a tool 30 placed within a pocket 6 comprising a step-down 29 at one end of the base 8. Note that, for clarity, other changes in the z-dimension of the pocket 6 have been omitted from FIG. 5. As shown in FIG. 5, the tool 30 sits on a level above the step-down 29 in the base 8 of the pocket 6. This allows the end 30a of the tool 30 which is held above the base of the step-down 29 to be pressed down into the step-down 29 such that the other end 30b of the tool 30 is raised up out of the pocket 6, allowing an engineer to easily lift the tool 30 out of the pocket 6. It will be understood that the step-down 29 need not necessarily be provided at one end of the pocket; rather, it may be placed at any suitable location (which is typically, but not necessarily, adjacent to an edge of the pocket).

Depth transition lines may be provided to indicate where the z-dimension value changes from one z-dimension value to another. In FIG. 4, three straight depth transition lines 34, 36, 38 are provided, each depth transition line extending across the entire y-dimension of the model. This means that: each (x, y) position of the model to the left of the first depth transition line 34 is provided with the first z-dimension value 20; each (x, y) position of the model between the first and second depth transition lines 34, 36 is provided with the second z-dimension value 22; each (x, y) position of the model between the second and third depth transition lines 36, 38 is provided with the third z-dimension value 24; and each (x, y) position of the model to the right of the third depth transition line 38 is provided with the fourth z-dimension value 26. However, it will be understood that more complex depth information could be provided which varies along the width (y-dimension) of the 2D model. For example, depth transition lines may be, for example, curved or stepped rather than straight.

As mentioned above, in each section demarked by depth transition lines, the base of the 2.5D model is substantially flat. This contrasts with a full 3D model, where the base of the model would conform to the contours of a corresponding base of the tool.

The depth information in the z-dimension combined with the 2D silhouette of the tool provides a 2.5D computer model representing a three dimensional shape at least partly derived from the shape of the tool 10, said three dimensional shape having a varying depth profile. A computer representation of a kitting foam comprising three pockets, each conforming to the three dimensional shape derived from the tool 10.

As illustrated in FIG. 7, once the computer model has been created using the CAD package in computer 40, the model is input to a Computer Aided Manufacturing (CAM) package being stored and ran on a second computer 42 which may be part of, or may be configured to (typically electronically) communicate with, an automated cutting machine 44. An example of a suitable CAM package is “Machining Strategist”. The CAM package derives the most efficient cutter path for cutting out a pocket in a kitting foam blank 1 in accordance with the 2.5D computer model. Such a pocket will have a varying depth profile conforming to the varying depth profile of the three dimensional shape of the computer model. As shown in FIG. 5, the varying depth profile extends between the opening 7 in the upper surface 2a of the foam blank 1 and the base 8.

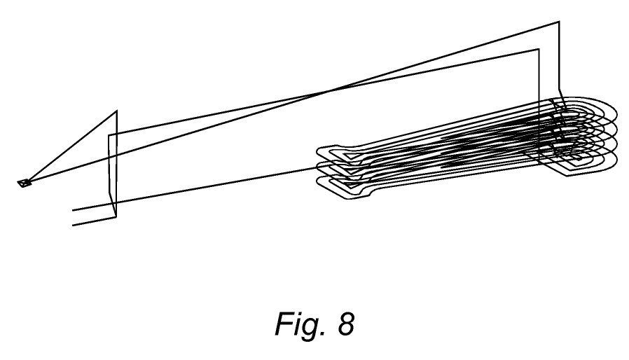

Because the three dimensional shape of the pocket to be formed in the kitting foam is provided to the CAM package before any cutting is performed, the CAM package typically derives a single, continuous three dimensional cutter path which can be followed to form the pocket. Such a cutter path is illustrated in FIG. 8.

Preferably, the cutter path is calculated such that a pocket with a varying depth profile may be cut-out of the foam in a single pass of the cutting tool over the foam.

The CAM package (or alternatively another computer program) is then used to control an automated cutting machine 44 to cut out a pocket in the kitting foam blank 1 by following the cutter path derived from the computer model.

It is noted that the applicant is unaware of any prior public use (or suggestion of use) of 2.5D or 3D data in an automated process for cutting a pocket in a kitting foam, or of the prior public use of a 3D CAM package to derive a cutter path for cutting a pocket in a kitting foam.

A possible alternative method of forming a pocket with a varying depth profile would be to perform multiple cutting operations on the foam using multiple independent 2D (x, y) computer models each representing a two dimensional shape, each 2D shape being cut out of the kitting foam blank 1 to a different depth in the z-dimension. In this case it would be necessary to provide the automated cutting machine 44 (such as a CNC machine) with a plurality of discontinuous cutting paths, whereby the cutting machine 44 performs multiple independent passes over the kitting foam, each pass involving cutting the foam to a single constant depth. However, this would be time consuming and prone to errors, particularly because it would be necessary to realign the cutting tool at the start of each successive cutting path.

The inventors have realised that by providing a computer model representing a three dimensional shape to the automated cutting machine 44 in accordance with the above method, a single, continuous three dimensional cutting path can be calculated. This facilitates a much quicker (and therefore less expensive) and more accurate cutting process, making the manufacture of small quantities of (and even single “one-off”) kitting foams much more cost effective and less prone to error.

It will be understood that, although FIG. 7 illustrates the CAD package and CAM packages as being stored and ran on separate computers 40, 42, the CAD and CAM packages may alternatively be stored and ran on a single computer. The automated cutting machine 44 may also be controlled by a separate computer, with the cutter path calculated by the CAM package being input to that computer.

It will be understood that the 2.5D computer model described above may be replaced with a full 3D computer model of the tool 10. A full 3D model comprises a distinct z-dimension value for each (x, y) position of the model. Such a 3D model may be obtained by, for example, laser scanning the tool 1. As above, by inputting the 3D model directly into the CAM package, the CAM package can calculate a single, continuous three dimensional cutter path which allows the pocket to be cut into the kitting foam in a single pass of a cutting machine 44 over the foam. The improvements in speed and accuracy obtained by instructing the cutting machine to follow a single, optimised, three dimensional cutter path over the foam blank 1 is again achieved. However, generating a full 3D model is time consuming compared to a 2.5D model and the tools required to achieve such a 3D model (e.g. a laser scanner) are expensive. In addition, the inventors have found that obtaining a 3D model is unnecessary because the 2.5D model described above is more than adequate to achieve a pocket having a snug fit around the tool 10 and which provides a desired profile of the tool 10 when it is placed within the pocket.

It is also noted that a full 3D model may have to be amended manually to provide one or more step-downs 29 to enable a tool to be easily removed from the pocket without the need to cut out finger grooves in the foam. This would add further complexity to the method. It is therefore preferable to use 2.5D models in the above process rather than 3D models.

Once a 2.5D or 3D model of a tool is derived, it may be stored in a digital catalogue (or “database”) of such models. One or more computer models fed into computer 42 may simply be selected from such a catalogue of models, making it unnecessary to derive each model every time a kitting foam is manufactured. The rich, three dimensional information provided by the 2.5D or 3D computer models makes subsequent kitting foam designs extremely flexible and quick to arrange.

Multiple independent 2.5D and/or 3D models (whether they are obtained from a catalogue or obtained using the process described above) may be input to the CAM package before the CAM package calculates the single three dimensional cutter path, so that the automated cutting machine 44 can cut multiple tool pockets in the kitting foam blank by following a single (preferably continuous) cutter path. Alternatively, a single 2.5D or 3D model comprising a plurality of three dimensional shapes, each having a varying depth profile, may be input to the CAM package. This would also allow the automated cutting machine 44 to cut multiple tool pockets in the kitting foam blank by following a single (preferably continuous) cutter path.

While this detailed description has set forth some embodiments of the present disclosure, the appended claims cover other embodiments of the present disclosure which may differ from the described embodiments according to various modifications and improvements.

1. A method of producing a kitting foam, the method comprising:
a. providing a foam blank;
b. providing a computer model of a three dimensional shape having a varying depth profile;
c. deriving a cutter path at least partly from the computer model; and
d. cutting the foam blank along the cutter path to form a pocket in the foam blank, the pocket having a varying depth profile conforming to the varying depth profile of the three dimensional shape.

2. The method of claim 1 wherein the cutter path is substantially continuous.

3. The method of claim 1 wherein the computer model is a 2.5D computer model.

4. The method of claim 1 wherein the computer model comprises a silhouette in first and second dimensions of an object to be held by the pocket.

5. The method of claim 4 wherein the computer model further comprises first and second depths in a third dimension, the first depth being different from the second depth.

6. The method of claim 5 wherein the computer model further comprises a depth transition line indicating where the depth of the computer model in the third dimension changes from the first depth to the second depth.

7. The method of claim 6 wherein the pocket comprises a base having a step between the first and second depths in the third dimension in accordance with the depth transition line.

8. The method of claim 4 wherein the pocket comprises an opening shaped in accordance with the silhouette.

9. The method of claim 1 further comprising generating the computer model by: obtaining a silhouette of an object in first and second dimensions; providing first and second depths in a third dimension, the first depth being different from the second depth; and providing a depth transition line indicating where the depth in the third dimension changes from the first depth to the second depth.

10. The method of claim 9 further comprising referencing the silhouette of the object to a plurality of fiducial points separated by a predetermined distance to scale the silhouette in accordance with the size of the object.

11. The method of claim 9 wherein the method further comprises storing the generated computer model in a library of computer models.

12. The method of claim 1 further comprising selecting the computer model from a library of predetermined computer models in step b.

13. The method of claim 1 further comprising using a computer aided manufacturing software package to derive the cutter path from the computer model during step c.

14. The method of claim 1 wherein step d comprises controlling the cutting tool with a computer aided manufacturing software package.

15. The method of claim 1 wherein the cutting tool is an automated cutting tool.

16. The method of claim 15 further comprising using a computer aided manufacturing software package to derive the cutter path from the computer model during step c, wherein the computer aided manufacturing package is run on a computer which is part of, or configured to communicate with, the automated cutting tool.

17. The method of claim 15 wherein step d comprises controlling the cutting tool with a computer aided manufacturing software package and the computer aided manufacturing package is run on a computer which is part of, or configured to communicate with, the automated cutting tool.

18. The method of claim 1 wherein the cutting tool is a CNC cutting machine.

19. The method of claim 1 further comprising: providing a computer model of a plurality of three dimensional shapes, each shape having a varying depth profile; deriving a cutter path from the computer model; and cutting the foam blank along the cutter path to form a plurality of pockets in the foam blank, each pocket having a varying depth profile which conforms to the varying depth profile of a respective one of the three dimensional shapes.

20. The method of claim 1 wherein the foam blank comprises a first layer stacked on a second layer.

21. The method of claim 20 wherein the first layer comprises a first colour and the second layer comprises a second colour, the first colour contrasting with the second colour.

22. The method of claim 20 wherein the first and second layers of the foam blank are bonded together before step d.

23. The method of claim 20 wherein the or each pocket comprises an opening, step d further comprising cutting through the first layer so that the second layer becomes visible through the opening.

24. The method of claim 23 wherein step d comprises cutting through none of or only part of the thickness of the second layer.

25. A kitting foam manufactured by the method of claim 1.

26. A system for performing the method of claim 1, the system comprising: a computer loaded with a computer aided manufacturing software package capable of deriving a cutter path at least partly from a computer model of a three dimensional shape having a varying depth profile; and an automated cutter capable of cutting a foam blank along the cutter path to form a pocket in the foam blank, the pocket having a varying depth profile conforming to the varying depth profile of the three dimensional shape.

27. The system of claim 26 further comprising: a camera; and a computer loaded with a computer aided design software package capable of generating the computer model at least partly from a photograph taken by the camera.

28. The system of claim 26 further comprising a computer memory storing a plurality of computer models, each representing a different three dimensional shape having a varying depth profile.

29. The system of claim 26 wherein the computer loaded with the computer aided manufacturing software package is in electronic communication with the automated cutter.
